(19) United States
(12) Patent Application Publication
(10) Pub. No.: US 2025/0367844 A1
(43) Pub. Date: Dec. 4, 2025

(54) SLICING MACHINE, SYSTEM AND METHOD

(71) Applicant: MULTIVAC SEPP HAGGENMÜLLER SE & CO. KG, Wolfertschwenden (DE)

(72) Inventor: Tom STACHEL, Kempten (DE)

(73) Assignee: MULTIVAC SEPP HAGGENMÜLLER SE & CO. KG, Wolfertschwenden (DE)

(21) Appl. No.: 19/177,875

(22) Filed: Apr. 14, 2025

(30) Foreign Application Priority Data
Apr. 19, 2024 (DE) 102024110985.8

(51) Int. Cl. B26D 7/30; B26D 5/00; B26D 7/06

(52) U.S. Cl. CPC B26D 7/30; B26D 5/00; B26D 7/0616; B26D 7/0683; B26D 2210/02

(57) ABSTRACT

The disclosure relates to a slicing machine for slicing foods, comprising: a feed unit adapted to feed at least one product caliber in a feed direction, a cutting unit, and a control unit adapted to control at least the feed unit and the cutting unit. The control unit is adapted to be in signal connection with a processing apparatus separate from the slicing machine. The processing apparatus is adapted to process the product caliber before it is sliced by the slicing machine. The control unit is further adapted to receive at least one dimension and/or a weight and/or a density of the at least one product caliber or data representative thereof from the processing apparatus and to control the feed unit and/or the cutting unit based on the at least one dimension and/or the weight and/or the density. The disclosure relates further to a system and to a method.

### CROSS-REFERENCE TO RELATED APPLICATIONS

This application claims foreign priority benefits under 35 U.S.C. § 119 (a)-(d) to German patent application number DE 102024110985.8, filed Apr. 19, 2024, which is incorporated by reference in its entirety.

### SUMMARY

The disclosure relates to a slicing machine, in particular a slicer, for slicing foods, comprising a feed unit, which is adapted to feed at least one product caliber in a feed direction, a cutting unit, which is adapted to slice the at least one product caliber into slices, and a control unit, which is adapted to control at least the feed unit and the cutting unit.

It should be noted at this point that the slicing machine is provided according to the disclosure to slice foods, in particular in the form of so-called product calibers, into slices, from which preferably shingled or stacked portions can be formed. The product calibers can be formed, for example, of sausage, cheese, cultivated meat, pressed meat and the like. The feed unit can be configured, for example, as a continuously revolving belt conveyor or the like. The cutting unit is preferably arranged, with reference to the feed direction, downstream of the feed unit. The cutting unit can comprise a blade, which can be driven in rotation about an axis of rotation. By means of the blade, the slices can be cut from an end of a respective product caliber facing towards the cutting unit.

If the product calibers are produced, for example, from cultivated meat, such as, for example, bacon or smoked ham, it is known to press the product calibers, before they are sliced by the slicing machine, by means of a processing apparatus in the form of a pressing apparatus, for example in a transverse direction and/or a height direction of the product caliber, in order that the product caliber, during subsequent slicing by the cutting machine, has a cross section that is substantially constant or at least as constant as possible in the length direction. It can thus be ensured that slices of approximately equal thickness that are sliced from the product caliber by the slicing machine also have a substantially equal or at least similar weight. After pressing by the pressing apparatus, the at least one product caliber can be transferred, for example manually or in an automated or semi-automated manner, to the feed unit of the slicing machine.

According to the prior art, a scanning device, for example an optical scanning device, is often provided at the feed unit of the slicing machine as a component of the slicing machine, said scanning device being adapted to determine at least one or more external dimensions and/or a volume of the product caliber as parameters of the product caliber. Furthermore, a weighing device can optionally be arranged at the feed unit of the slicing machine, by means of which weighing device a weight of a respective product caliber can be determined. A control unit of the slicing machine can accordingly determine from the one or the multiple external dimensions and/or the volume and the weight and/or the density of the respective product caliber a slice thickness to be sliced that is required in order that a slice ideally has a predetermined target weight or at most a predetermined deviation from the predetermined target weight.

It is a disadvantage that such scanning devices, such as, for example, a volumetric scanning device or an X-ray scanning device, can not only be cost-intensive but can also require maintenance. Overall, it is therefore desirable to equip the slicing machine with the smallest possible number of sensor systems, such as, for example, scanning devices and/or weighing devices and/or other measuring devices. At the same time, however, it must be ensured that a slicing result that is achievable by the slicing machine is not impacted to an undesirable extent or even made worse.

Accordingly, an object of the disclosure is to provide a remedy here, in particular by providing a slicing machine which has the smallest possible number of acquisition units, such as, for example, sensor systems or the like, for determining product caliber parameters and/or other properties of the at least one product caliber.

This object is achieved according to the disclosure by a slicing machine of the type mentioned at the beginning in which the control unit is adapted to be in signal connection with a processing apparatus that is separate from the slicing machine, wherein the processing apparatus is adapted to process the product caliber before it is sliced by the slicing machine, and the control unit is further adapted to receive at least one dimension and/or a weight and/or a density of the at least one product caliber or data representative thereof from the separate processing apparatus and to control the feed unit and/or the cutting unit on the basis of the at least one dimension and/or of the weight and/or of the density.

Since, according to the disclosure, the product caliber parameters in the form of the at least one dimension and/or the weight and/or the density of the at least one product caliber are acquired at the processing apparatus, which in particular is located upstream of the slicing machine, it is preferably no longer necessary for the slicing machine to be provided with acquisition units, such as, for example, sensor systems or the like, which are provided for acquiring these product caliber parameters. Consequently, there can be provided a slicing machine that is preferably able to operate without complex scanning devices that require maintenance and are particularly cost-intensive, such as, for example, a volumetric scanning device and/or an X-ray scanning device.

The inventor can be credited with recognizing that, if the slicing machine and the separate processing apparatus are components of the same production line, the product caliber parameters in the form of the at least one dimension and/or the weight and/or the density of the product caliber are often already acquired at the processing apparatus located upstream of the slicing machine, and a redundant acquisition of these product caliber parameters at the slicing machine can therefore be dispensed with.

From the at least one external dimension and/or the weight and/or the density of the particular product caliber, the control unit of the slicing machine is accordingly able to determine a slice thickness to be sliced that is required in order that a slice sliced from the at least one product caliber ideally has a predetermined target weight or at most a predetermined deviation from the predetermined target weight.

While the slicing machine is being used, it can be at a predetermined distance, for example several meters, from the processing apparatus or can be arranged directly at or next to the processing apparatus.

According to one exemplary embodiment, the at least one dimension can be a width in a width direction and/or a height in a height direction and/or a length in a length direction and/or a volume of the at least one product caliber. In principle, it can be sufficient for the control unit to receive only one or some of the mentioned dimensions from the separate processing apparatus. This is the case, for example, when only one of the dimensions, for example the width, of successive product calibers to be sliced varies, but the other dimensions, for example the height and/or the length, is/are, for example, constant. This can be the case, for example, with cheese wheels or blocks of cheese, which, before they are sliced, are often divided by corresponding longitudinal cuts in the length direction into multiple pieces, in particular of unequal width but equal length.

According to a particularly preferred exemplary embodiment, the separate processing apparatus can be a pressing apparatus, which is adapted to press the at least one product caliber in the width direction and/or in the height direction and/or in the length direction of the at least one product caliber. If, for example, a product caliber in the form of bacon or smoked ham or the like is pressed by the pressing apparatus to predetermined external dimensions and/or to a predetermined volume, the processing apparatus in the form of the pressing apparatus can transmit these data to the control unit of the slicing machine, so that these data do not have to be acquired again by the slicing machine itself.

Alternatively, the separate processing apparatus can be, for example, a dividing apparatus, in particular a cheese dividing apparatus, which is adapted to divide the at least one product caliber, before it is sliced, into two or more parts in the length direction, as described above. The separate processing apparatus can further be a skinning apparatus, for example a sausage skinning apparatus, which is adapted to remove a casing such as a skin or other packaging from the at least one product caliber. The skinning apparatus can preferably be adapted to determine at least a length of the at least one product caliber.

If the separate processing apparatus is the pressing apparatus described above, the pressing apparatus, according to a further development, can comprise a transverse pressing unit, which is adapted to press the product caliber in the width direction, and/or a vertical pressing unit, which is adapted to press the product caliber in the height direction, and/or a longitudinal pressing unit, which is adapted to press the product caliber in the length direction. The pressing apparatus can be adapted to press the product caliber in at least one dimension, i.e. direction, but also, if desired, in at least two or in all three spatial directions, which can also be referred to as “3D pressing”. The mentioned pressing units can preferably be configured as pressing dies.

According to yet a further development, the control unit and/or the pressing apparatus can be adapted to determine the at least one dimension of the product caliber from a position of the transverse pressing unit and/or of the vertical pressing unit and/or of the longitudinal pressing unit when the at least one product caliber has reached a predetermined pressed state. In other words, an end position of the pressing units, in particular of the pressing dies, can be used for determining the at least one dimension. It is here conceivable, on the one hand, that the pressing apparatus is adapted to transmit to the control unit position data which correspond to the respective end position of one or more of the pressing units, and the control unit is adapted to determine the at least one dimension of the product caliber from the position data. On the other hand, the pressing apparatus itself can also be adapted to determine the at least one dimension from the end position of one or more of the pressing units and to transmit the at least one dimension, preferably directly, to the control unit of the slicing machine.

In principle, the control unit and/or the processing apparatus can be adapted, in the case of a known material, in particular a known density of the material, of the at least one product caliber, to determine the weight by evaluating the external dimensions, in particular the volume, of the at least one product caliber. According to a further exemplary embodiment, however, it is proposed that the separate processing apparatus comprises a weighing device, which is adapted to determine the weight of the at least one product caliber.

In order to be able to forward or transmit further product caliber parameters, in particular apart from the at least one predetermined dimension, the weight and/or the density, from the separate processing apparatus to the slicing machine, the separate processing apparatus can comprise a further acquisition device, which is adapted to determine at least one further product caliber parameter, in particular a temperature and/or a firmness and/or a hardness of the product caliber, wherein the control unit can further be adapted also to receive the at least one further product caliber parameter or data representative thereof from the separate processing apparatus.

Owing to the above-mentioned interaction between the control unit of the slicing machine on the one hand and the separate processing apparatus on the other hand, the slicing machine can preferably be free of a scanning device, in particular a volumetric scanning device and/or an X-ray scanning device, and/or of a weighing device for the at least one product caliber. If a scanning device and/or a weighing device is arranged at the separate processing apparatus, which however is not absolutely necessary, at least a redundant provision of a scanning device and/or of a weighing device can be prevented.

In order to ensure frictionless transfer of the product caliber parameters and/or of the data representative thereof between the separate processing apparatus and the control unit, the separate processing apparatus and the control unit of the slicing machine can be in signal connection with one another preferably wirelessly or by means of at least one data communication line. Communication can accordingly take place wirelessly or in a wired manner. It is further conceivable to provide an external server and/or memory, which can be accessed by the control unit of the slicing machine and/or by the separate processing apparatus, so that the slicing machine and the processing apparatus do not necessarily have to be directly connected together for data communication.

It should also be added that the slicing machine can further comprise a gripper unit having at least one gripper, which is adapted to grip the at least one product caliber at its end remote from the cutting unit.

In addition or alternatively, the slicing machine can, in a manner known per se, further comprise a portioning unit, which is adapted to form portions from the slices cut by the cutting unit, wherein each portion can comprise one or more slices.

It should further be added that the slicing machine can comprise a discharge unit, which is adapted to discharge the slices cut by the cutting unit in a discharge direction, in particular for further processing by a packaging machine.

According to a further aspect, the disclosure relates to a system comprising the above-described slicing machine according to the disclosure and the processing apparatus separate from the slicing machine.

With regard to the advantages and effects of the system according to the disclosure, reference is made to the advantages and effects of the slicing machine according to the disclosure, all statements made in relation to the slicing machine also applying to the system and vice versa.

According to yet a further aspect, the disclosure relates to a method for slicing foods by means of a slicing machine, in particular a slicing machine according to the disclosure, or by means of a system according to the disclosure, which method comprises the following steps:
feeding, by means of a feed unit of the slicing machine, at least one product caliber in a feed direction,
slicing, by means of a cutting unit of the slicing machine, the at least one product caliber into slices, and
controlling, by means of a control unit of the slicing machine, at least the feed unit and the cutting unit,
wherein the control unit is in signal connection with a processing apparatus separate from the slicing machine, said processing apparatus processing the product caliber before it is sliced by the slicing machine, and
the control unit receives at least one dimension and/or a weight and/or a density of the at least one product caliber or data representative thereof from the separate processing apparatus and controls the feed unit and/or the cutting unit on the basis of the at least one dimension and/or of the weight and/or of the density.

With regard to the advantages and effects of the method according to the disclosure, reference is made to the advantages and effects of the slicing machine according to the disclosure and/or of the system according to the disclosure, all statements made in relation to the slicing machine and/or the system also applying to the method and vice versa.

According to one exemplary embodiment, the at least one dimension can be a width in a width direction and/or a height in a height direction and/or a length in a length direction and/or a volume of the at least one product caliber.

### BRIEF DESCRIPTION OF THE DRAWINGS

Exemplary embodiments according to the disclosure will be explained in greater detail hereinbelow with reference to the accompanying drawings, in which:

FIG. 1a shows an exemplary embodiment of a slicing machine according to the disclosure in a perspective view;

FIG. 1b shows the slicing machine according to FIG. 1a in a side view;

FIG. 2a is a schematic view of an exemplary embodiment of a system according to the disclosure comprising a slicing machine according to the disclosure and a processing apparatus separate from the slicing machine;

FIG. 2b shows an exemplary embodiment of the processing apparatus in the form of a pressing apparatus, according to a cutaway side view; and

FIG. 2c shows the pressing apparatus according to FIG. 2b according to a cutaway front view.

### DETAILED DESCRIPTION

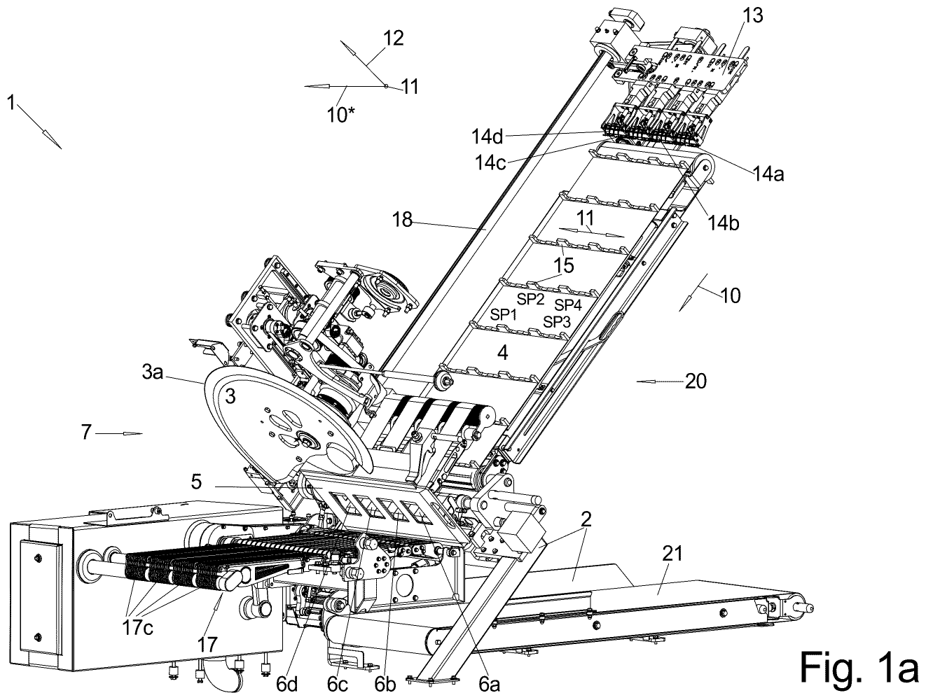

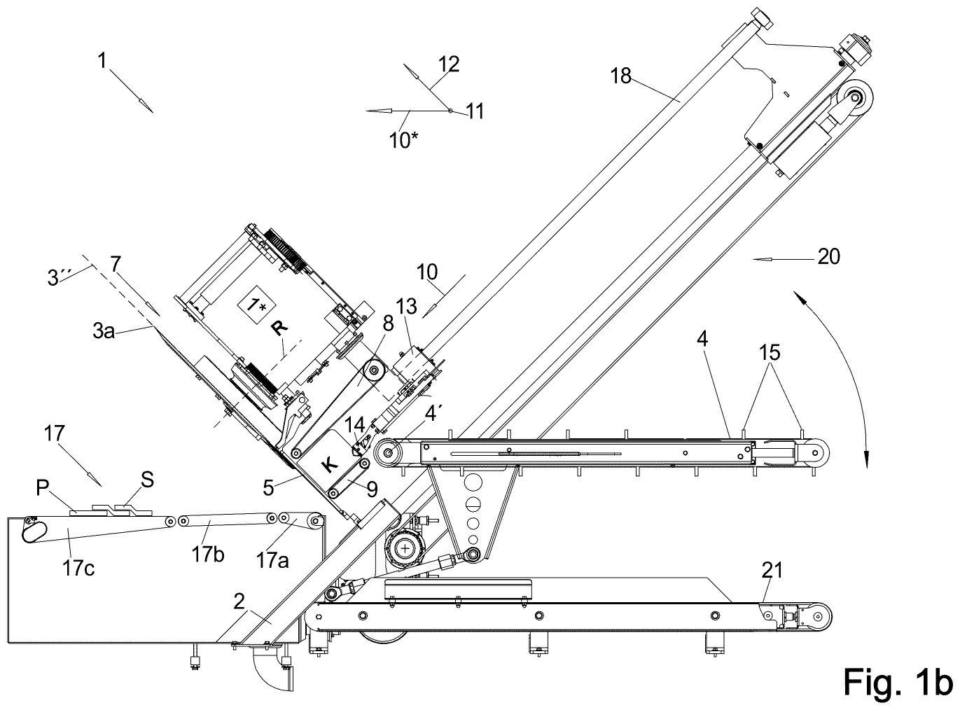

FIGS. 1a and 1b show a slicing machine 1 according to the disclosure according to an exemplary embodiment in the form of a multi-track slicer 1 for simultaneously slicing multiple product calibers K each on one track SP1 to SP4 lying adjacent to one another, and depositing them in shingled portions P each consisting of multiple slices S, with a general throughput direction 10* through the slicer 1 from right to left.

FIG. 1b shows—with product caliber K inserted-a side view of the slicer 1, omitting covers and other parts which are attached to a base frame 2, so that the functional parts, especially the conveyor belts, are more clearly visible. The longitudinal direction 10 is the feed direction of the product calibers K to a cutting unit 7 and thus also the length direction of the product calibers K lying in the slicer 1.

Multiple, in this case four, product calibers K lying adjacent to one another transversely to the feed direction 10 on a feed conveyor 4, which product calibers have between them as spacers projections 15 of the feed conveyor 4 that protrude from a supporting surface, can here be fed by a feed unit 20 to a cutting unit 7 of the slicer 1 having a blade 3, for example a sickle blade 3, rotating about an axis of rotation R, the rotating blade 3 being able to cut a slice S from the front ends of said product calibers with its cutting edge 3a on each revolution about the axis of rotation R.

For slicing the product calibers K, the feed conveyor 4 is in the inclined slicing position shown in FIG. 1a, with the cutting-side front end lying low and the rear end lying high, from which it can be lowered about a pivot axis 4′ running in its width direction, the first transverse direction 11, and located close to the cutting unit 7, to an approximately horizontal loading position, as shown in FIG. 1b.

The rear end of each product caliber K lying in the feed unit 20 is held in a form-fitting manner by a gripper 14, or 14a-d, with the aid of gripper claws. These grippers 14, or 14a-14d, which can be activated and deactivated with respect to the position of the gripper claws 16, are attached to a common gripper unit 13, which can be moved along a gripper guide 18 in the feed direction 10.

The feed of both the gripper unit 13 and the feed conveyor 4 can be driven in a controlled manner, but the actual feed speed of the product calibers K can be effected by so-called upper and lower product guides 8, 9, which are also driven in a controlled manner, said guides engaging the upper side and the lower side of the product calibers K to be sliced in their front end regions close to the cutting unit 7.

The front ends of the product calibers K are each guided through a product opening 6a-d of a plate-like cutting frame 5, wherein the cutting plane 3″ in which the blade 3 rotates with its cutting edge 3a about the axis of rotation R and thus cuts off the end of the product calibers K projecting from the cutting frame 5 as a slice S, runs immediately in front of the front, downwardly inclined end face of the cutting frame 5. The cutting plane 3″ runs orthogonally to the upper run of the feed conveyor 4 and/or is spanned by the two transverse directions 11, 12 to the feed direction 10. The inner circumference of the product openings 6a-d serves as a counter-edge for the cutting edge 3a of the blade 3.

Since the two product guides 8, 9 can be driven in a controlled manner, in particular independently of one another and/or possibly separately for each track SP1 to SP4, they determine a-continuous or timed-feed speed of the product calibers K through the cutting frame 5.

The upper product guide 8 can be displaced in the second transverse direction 12, which runs orthogonally to the surface of the upper run of the feed conveyor 4, in order to adapt to a height of the product caliber K in this direction. Furthermore, at least one of the product guides 8, 9 can be configured to be pivotable about one of its pulleys in order to be able to change, to a limited extent, the direction of a guide belt, in contact with the respective product caliber K, of the product guide 8 and/or 9.

The slices S standing obliquely in the space while they are being cut fall onto a discharge unit 17, which starts beneath the cutting frame 5 and runs in the throughput direction 10* and which in the exemplary embodiment shown comprises a plurality of discharge conveyors 17a, 17b, 17c arranged one after the other in the throughput direction 10*, of which the first discharge conveyor 17a in the throughput direction 10* can be configured as a weighing unit 17a and in particular also as a portioning belt.

The slices S can arrive on the discharge unit 17 individually and spaced apart from one another in the throughput direction 10*, or shingled or stacked portions P (see FIG. 1b) can be formed by appropriate control of the weighing unit 17a, whose movement, like almost all the moving parts, is controlled by a control unit 1* of the slicer 1. The portions P can be formed, for example, by a stepwise forward movement of the weighing unit 17a, which in the present case also serves as a portioning belt, in the throughput direction 10*.

Beneath the feed unit 20 there is in the exemplary embodiment shown a residue conveyor 21 running substantially horizontally, said residue conveyor starting with its front end beneath the cutting frame 5 and directly beneath or behind the discharge unit 17 and, with its upper run, being able to transport away backwards residues that fall thereon.

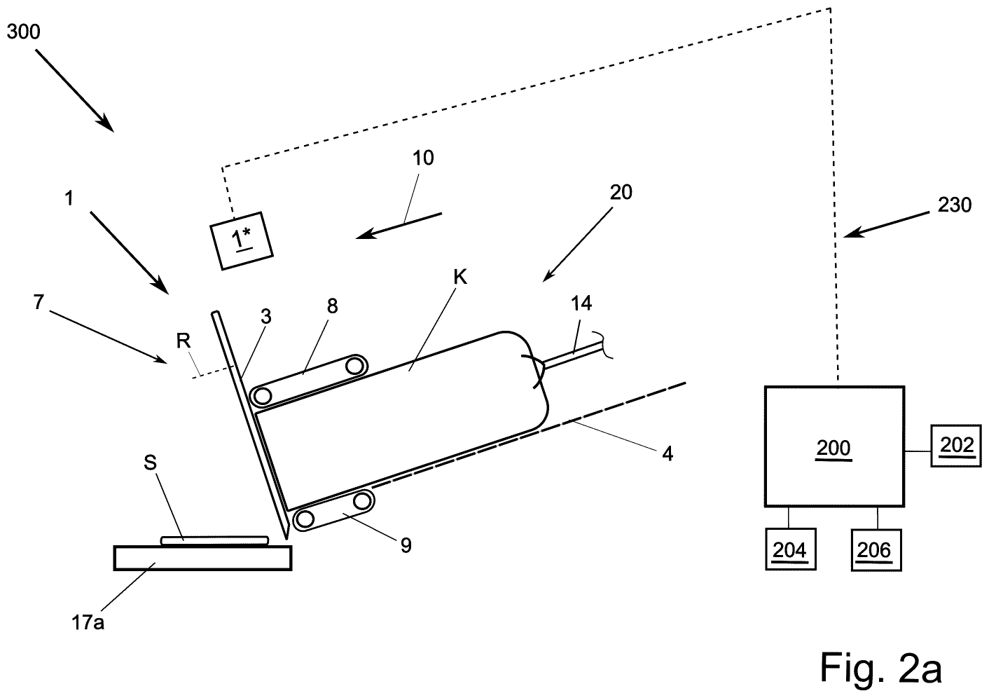

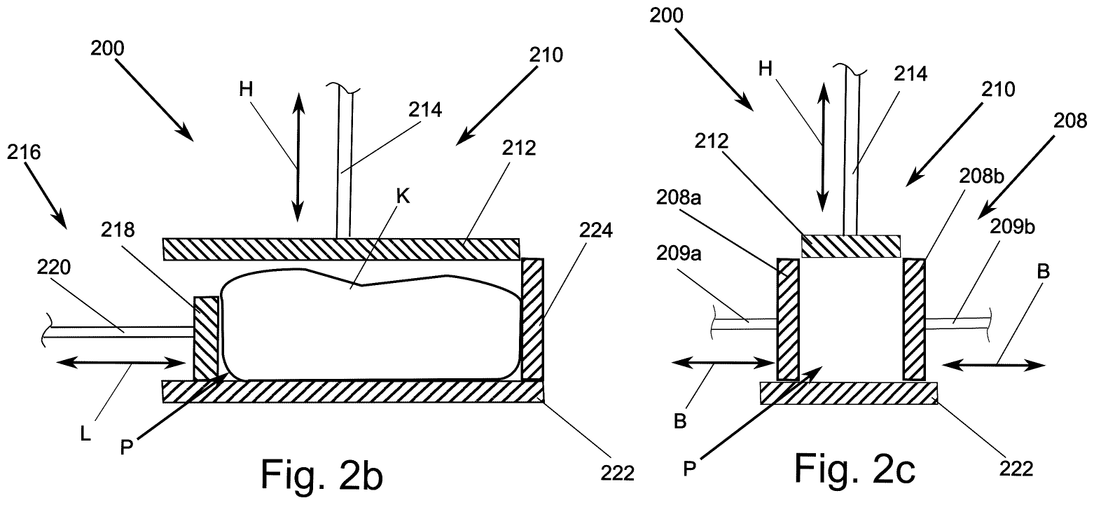

FIG. 2a shows a schematic view of a system 300 according to the disclosure, which comprises a slicing machine 1 and also a processing apparatus 200 separate from the slicing machine. The slicing machine 1, which is shown only schematically in FIG. 2a, can correspond in terms of its functioning to the slicing machine 1 described above with reference to FIGS. 1a and 1b. The feed unit 20 with the feed conveyor 4, the blade 3 of the cutting unit 7 and the control unit 1* as well as the upper product guide 8, the lower product guide 9 and the gripper 14 are shown only schematically in FIG. 2a.

The control unit 1*, which is likewise shown only schematically in FIG. 2a, is adapted according to the disclosure to be in signal connection with the processing apparatus 200 separate from the slicing machine 1, wherein the connection can be adapted to be wired, for example by way of a data communication line 230, or wireless. According to the disclosure, the processing apparatus 200 is adapted to process, preferably to press, the product caliber K before it is sliced by the slicing machine 1. Alternatively, the processing apparatus 200 can likewise be adapted to divide the product caliber K by means of longitudinal cuts substantially parallel to the feed direction 10 (e.g., with a cutting unit having a cutting blade), which can be the case, for example, with blocks of cheese, in particular so-called Euro blocks. The processing apparatus 200 can further be a skinning apparatus, for example, which can be adapted to remove a skin from the product caliber K, which can be necessary, for example, in the case of salami or the like.

The processing apparatus 200 can comprise, for example, a weighing device 202, which is likewise shown only schematically in FIG. 2a. The weighing device 202 can be adapted to determine the weight of the at least one product caliber K and then to transmit said weight to the control unit 1*, so that the weight does not have to be determined again at the slicing machine 1 because it is already known from a previous step of processing the at least one product caliber K at the processing apparatus 200.

The processing apparatus 200 can additionally comprise a scanning device 204, likewise indicated only schematically in FIG. 2a, which can be adapted to determine at least one dimension of the product caliber, for example a width and/or a height and/or a length and/or a volume of the at least one product caliber K.

The processing apparatus 200 can further comprise a further acquisition device 206, shown schematically, which can be adapted to determine at least one further product caliber parameter, in particular a temperature and/or a firmness/hardness, of the product caliber K, wherein the control unit 1* can further be adapted to receive the at least one further product caliber parameter or data representative thereof from the separate processing apparatus 200.

A preferred embodiment of the processing apparatus 200 will now be described with reference to FIGS. 2b and 2c, in which embodiment the processing apparatus is configured as a pressing apparatus 200. The pressing apparatus 200 can be adapted to press the at least one product caliber K in a width direction B and/or in a height direction H and/or in a length direction L. To this end, the pressing apparatus 200 can comprise a transverse pressing unit 208, which can be adapted to press the product caliber K in the width direction B. As can be seen by way of example in FIG. 2c, the transverse pressing unit 208 can comprise two transverse pressing dies 208a and 208b, which are arranged opposite one another and can form mutually opposite side walls of a pressing space P in which the product caliber K can be placed and pressed to predetermined dimensions.

In the exemplary embodiment shown, the product caliber K is preferably a product caliber which, in a non-pressed state, i.e. before pressing, has a cross section that varies at least in the length direction L. It is therefore preferred, before the product caliber K is sliced by the slicing machine 1, to press the product caliber by means of the pressing apparatus 200 in such a manner that it has a substantially constant cross section in the length direction L. It can thus be ensured that slices S that are sliced from the product caliber K with a predetermined thickness have a weight that is approximately equal or at least as equal as possible. The product caliber K can be produced from or consist of, for example, cultivated meat, such as, for example, bacon or smoked ham.

The transverse pressing unit 208 can further comprise pressing force transmitting rods, for example piston rods 209a and 209b, which are arranged opposite one another and are adapted to move the transverse pressing dies 208a and 208b in the width direction B, that is to say towards one another and away from one another, in order to press the product caliber K in the width direction B.

The pressing apparatus 200 can further comprise a vertical pressing unit 210, which can be adapted to press the product caliber K in the height direction H. The vertical pressing unit 210 can comprise a vertical pressing die 212, which can be adjustable in the height direction H by means of a further piston rod 214 in order to press the product caliber K in the pressing space P to predetermined dimensions in the height direction H.

As can further be seen in FIG. 2b, the pressing apparatus 200 further comprises according to the exemplary embodiment shown a longitudinal pressing unit 216 having a longitudinal pressing die 218, which is adapted to press the product caliber K in the length direction L. To this end, the longitudinal pressing die 218 can likewise be operably connected to yet a further piston rod 220, by means of which the longitudinal pressing die 218 can be moved in the length direction L, that is to say towards and away from the product caliber K in FIG. 2b.

The piston rods 209a, 209b, 214 and 220, which can also be referred to generally as pressing force transmitting rods, can each be connected to a corresponding pressing force generating unit, such as, for example, a servomotor or a fluidically actuatable cylinder or the like, but this is not shown in FIGS. 2b and 2c.

During the pressing operation, the product caliber K in the exemplary embodiment shown lies in a pressing channel, which can be defined by a base 222 of the pressing apparatus 200 and the two transverse pressing dies 208a and 208b. The pressing apparatus 200 can further comprise a rear wall 224, which can be configured as a rigid rear wall and can serve as a counter-support during pressing by the longitudinal pressing unit 216.

It should additionally be noted that, for example, the longitudinal pressing unit 216, in particular the longitudinal pressing die 218, can have a protruding resilient portion (not shown in FIG. 2b), which can be adapted to adapt the longitudinal pressing die 218 to a dimension of the pressing space P in the height direction H. The protruding portion can be preloaded in the direction of the vertical pressing die 212, for example by means of a preloading unit, for example a spring.

According to a preferred exemplary embodiment, the control unit 1* and/or the pressing apparatus 200 can be adapted to determine the at least one dimension of the product caliber K, for example the length in the length direction L, the height in the height direction H and/or the width in the width direction B, from a position of the longitudinal pressing die 218 or from a position of the vertical pressing die 212 or from a position of the transverse pressing dies 208a and 208b, when said dies are in an end position in which the product caliber K has reached a predetermined pressed state.

The mentioned dimensions can be transmitted by the processing apparatus 200, that is to say in the present exemplary embodiment by the pressing apparatus 200, to the control unit 1* and correspondingly used for the slicing operation. The pressing apparatus 200 and/or the control unit 1* can further be adapted to determine from the mentioned dimensions a volume of the product caliber K and, optionally with the aid of a weight of the product caliber K determined by the weighing device 202, a density of the product caliber K.

With the system 300 according to the disclosure, it is therefore possible to acquire product caliber parameters in the form of the at least one dimension and/or of the weight and/or of the density of the product caliber K at the processing apparatus 200, in particular the pressing apparatus 200, located upstream of the slicing machine 1 and to transmit said parameters to the control unit 1* of the slicing machine 1 for further processing, so that a redundant acquisition and thus a redundant provision of corresponding sensor systems at the slicing machine 1 can be dispensed with.

The control unit 1* of the slicing machine 1 can determine from the at least one external dimension and/or the weight and/or the density of the product caliber K a slice thickness to be cut for the slices S, which thickness is necessary in order that a slice S sliced from the product caliber K has a predetermined target weight or at most a predetermined deviation from the predetermined target weight, and to control the feed unit 20 and/or the cutting unit 7 accordingly.

As one skilled in the art would understand, the control unit 1*, the processing apparatus 200, as well as any other control, controller, unit, system, subsystem, sensor, device (e.g., weighing device 202, scanning device 204, acquisition device 206, etc.), or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A slicing machine for slicing foods, comprising:
a feed unit, which is adapted to feed a product caliber in a feed direction,
a cutting unit, which is adapted to slice the product caliber into slices, and
a control unit, which is adapted to control at least the feed unit and the cutting unit,
wherein the control unit is adapted to be in signal connection with a processing apparatus that is separate from the slicing machine, wherein the processing apparatus is adapted to process the product caliber before it is sliced by the slicing machine, and wherein the control unit is further adapted to receive at least one dimension and/or a weight and/or a density of the product caliber or data representative thereof from the separate processing apparatus and to control the feed unit and/or the cutting unit based on the at least one dimension and/or the weight and/or the density.

2. The slicing machine as claimed in claim 1, wherein the at least one dimension is a width in a width direction and/or a height in a height direction and/or a length in a length direction and/or a volume of the product caliber.

3. The slicing machine as claimed in claim 1, wherein the separate processing apparatus is a pressing apparatus, which is adapted to press the product caliber in a width direction and/or in a height direction and/or in a length direction of the product caliber.

4. The slicing machine as claimed in claim 3, wherein the pressing apparatus comprises a transverse pressing unit, which is adapted to press the product caliber in the width direction, and/or a vertical pressing unit, which is adapted to press the product caliber in the height direction, and/or a longitudinal pressing unit, which is adapted to press the product caliber in the length direction.

5. The slicing machine as claimed in claim 4, wherein the control unit and/or the pressing apparatus are/is adapted to determine the at least one dimension of the product caliber from a position of the transverse pressing unit and/or of the vertical pressing unit and/or of the longitudinal pressing unit when the product caliber has reached a predetermined pressed state.

6. The slicing machine as claimed in claim 1, wherein the separate processing apparatus comprises a weighing device, which is adapted to determine the weight of the product caliber.

7. The slicing machine as claimed in claim 1, wherein the separate processing apparatus comprises a further acquisition device, which is adapted to determine at least one further product caliber parameter, wherein the control unit is further adapted also to receive the at least one further product caliber parameter or data representative thereof from the separate processing apparatus.

8. The slicing machine as claimed in claim 7, wherein the at least one further product caliber parameter comprises a temperature and/or a firmness/hardness of the product caliber.

9. The slicing machine as claimed in claim 1, wherein the slicing machine is free of a scanning device and/or of a weighing device for the product caliber.

10. The slicing machine as claimed in claim 1, wherein the slicing machine is free of a volumetric scanning device and an X-ray scanning device.

11. The slicing machine as claimed in claim 1, wherein the control unit of the slicing machine is adapted to be in signal communication with the separate processing apparatus wirelessly or by at least one data communication line.

12. A system comprising the slicing machine as claimed in claim 1 and the processing apparatus separate from the slicing machine.

13. A method for slicing foods by a slicing machine, the method comprising:
feeding, by a feed unit of the slicing machine, a product caliber in a feed direction,
slicing, by a cutting unit of the slicing machine, the product caliber into slices, and
controlling, by a control unit of the slicing machine, at least the feed unit and the cutting unit,
wherein the control unit is in signal connection with a processing apparatus separate from the slicing machine, the processing apparatus processing the product caliber before it is sliced by the slicing machine, and
wherein the control unit receives at least one dimension and/or a weight and/or a density of the product caliber or data representative thereof from the separate processing apparatus and controls the feed unit and/or the cutting unit based on the at least one dimension and/or the weight and/or the density.

14. The method as claimed in claim 13, wherein the at least one dimension is a width in a width direction and/or a height in a height direction and/or a length in a length direction and/or a volume of the product caliber.
